(19) United States
(12) Patent Application Publication
(10) Pub. No.: US 2020/0012476 A1
(43) Pub. Date: Jan. 9, 2020

(54) METHODS, SYSTEMS, AND MEDIA FOR IDENTIFYING, CURATING, AND PRESENTING AUDIO CONTENT

(71) Applicant: Google LLC, Mountain View, CA (US)

(72) Inventors: Jeannette Gatlin, Seattle, WA (US); Manish Gaudi, Seattle, WA (US)

(21) Appl. No.: 16/502,694

(22) Filed: Jul. 3, 2019

Related U.S. Application Data
(60) Provisional application No. 62/694,863, filed on Jul. 6, 2018.

(51) Int. Cl. G06F 3/16; G06F 3/0484; G06F 3/0481; G06F 16/638; G06F 16/68

(52) U.S. Cl. CPC G06F 3/165; G06F 3/0484; G06F 16/686; G06F 16/639; G06F 3/0481

(57) ABSTRACT

Methods, systems, and media for identifying, curating, and presenting audio content are provided. In some embodiments, the method comprises: causing a first user interface to be presented on a user device that indicates a plurality of categories of audio content; receiving, via the first user interface, an indication of a selected category of the plurality of categories of audio content; in response to receiving the indication of the selected category via the first user interface, causing a second user interface to be presented on the user device that indicates a plurality of durations of audio content; receiving, via the second user interface, an indication of a selected duration of audio content, wherein the selected duration indicates a minimum duration of audio content and a maximum duration of audio content; identifying a group of candidate audio content shows based at least on whether category associated with each show in the group of candidate audio content shows matches the category selected via the first user interface; selecting a subset of shows of the group of candidate audio content shows; identifying a group of candidate episodes associated with the subset of shows; selecting a subset of episodes of the group of candidate episodes based at least on whether a duration of each episode in the subset of episodes is greater than the minimum duration and less than the maximum duration corresponding to the duration selected via the second user interface; ranking the subset of episodes; and causing indications of the subset of episodes to be presented in a third user interface presented on the user device, wherein the indications of the subset of episodes are presented based on the ranking.

### CROSS-REFERENCE TO RELATED APPLICATION

This application claims the benefit of U.S. Provisional Patent Application No. 62/694,863, filed Jul. 6, 2018, which is hereby incorporated by reference herein in its entirety.

### TECHNICAL FIELD

The disclosed subject matter relates to methods, systems, and media for identifying, curating, and presenting audio content.

### BACKGROUND

Many people enjoy listening to audio content, such as by tuning to a radio show or subscribing to a podcast and playing a podcast episode. For example, people may enjoy listening to such audio content during a commute between home and work, while exercising, etc. In some cases, people may have difficulty identifying specific content that they would enjoy listening to, such as specific shows or episodes that align with their interests. Additionally, in some cases, people may have difficulty finding shows or episodes that are of a duration that is convenient for them to listen to, such as a duration that aligns with a duration of a commute.

Accordingly, it is desirable to provide new methods, systems, and media for identifying and presenting audio content.

### SUMMARY

Methods, systems, and media for identifying, curating, and presenting audio content are provided.

In accordance with some embodiments of the disclosed subject matter, a method for presenting audio content is provided, the method comprising: causing, using a hardware processor, a first user interface to be presented on a user device that indicates a plurality of categories of audio content; receiving, via the first user interface, an indication of a selected category of the plurality of categories of audio content; in response to receiving the indication of the selected category via the first user interface, causing a second user interface to be presented on the user device that indicates a plurality of durations of audio content; receiving, via the second user interface, an indication of a selected duration of audio content, wherein the selected duration indicates a minimum duration of audio content and a maximum duration of audio content; identifying a group of candidate audio content shows based at least on whether category associated with each show in the group of candidate audio content shows matches the category selected via the first user interface; selecting a subset of shows of the group of candidate audio content shows; identifying a group of candidate episodes associated with the subset of shows; selecting a subset of episodes of the group of candidate episodes based at least on whether a duration of each episode in the subset of episodes is greater than the minimum duration and less than the maximum duration corresponding to the duration selected via the second user interface; ranking the subset of episodes; and causing indications of the subset of episodes to be presented in a third user interface presented on the user device, wherein the indications of the subset of episodes are presented based on the ranking.

In some embodiments, ranking the subset of episodes comprises determining a likelihood a user of the user device will enjoy each episode in the subset of episodes, wherein the ranking is based on the likelihood.

In some embodiments, the group of candidate audio content shows are identified based on a popularity of each show in the group of candidate audio content shows.

In some embodiments, the group of candidate audio content shows are identified based on whether episodes associated with each show in the group of candidate audio content shows are likely to be relevant to a user of the user device after a predetermined duration of time has elapsed.

In some embodiments, the method further comprises: for an episode included in the group of candidate episodes, identifying a portion of the episode, wherein the portion of the episode includes audio content of a particular type; and generating a trimmed version of the episode that includes the identified portion of the episode, wherein the trimmed version of the episode is included in the subset of episodes.

In some embodiments, identifying the group of candidate episodes is based on an RSS feed associated with shows in the subset of shows.

In accordance with some embodiments of the disclosed subject matter, a system for presenting audio content is provided, the system comprising a memory and a hardware processor that, when executing computer executable instructions stored in the memory, is configured to: cause a first user interface to be presented on a user device that indicates a plurality of categories of audio content; receive, via the first user interface, an indication of a selected category of the plurality of categories of audio content; in response to receiving the indication of the selected category via the first user interface, cause a second user interface to be presented on the user device that indicates a plurality of durations of audio content; receive, via the second user interface, an indication of a selected duration of audio content, wherein the selected duration indicates a minimum duration of audio content and a maximum duration of audio content; identify a group of candidate audio content shows based at least on whether category associated with each show in the group of candidate audio content shows matches the category selected via the first user interface; select a subset of shows of the group of candidate audio content shows; identify a group of candidate episodes associated with the subset of shows; select a subset of episodes of the group of candidate episodes based at least on whether a duration of each episode in the subset of episodes is greater than the minimum duration and less than the maximum duration corresponding to the duration selected via the second user interface; rank the subset of episodes; and cause indications of the subset of episodes to be presented in a third user interface presented on the user device, wherein the indications of the subset of episodes are presented based on the ranking.

In accordance with some embodiments of the disclosed subject matter, a non-transitory computer-readable medium containing computer executable instructions that, when executed by a processor, cause the processor to perform a method for presenting audio content is provided, the method comprising: causing a first user interface to be presented on a user device that indicates a plurality of categories of audio content; receiving, via the first user interface, an indication of a selected category of the plurality of categories of audio content; in response to receiving the indication of the selected category via the first user interface, causing a second user interface to be presented on the user device that indicates a plurality of durations of audio content; receiving, via the second user interface, an indication of a selected duration of audio content, wherein the selected duration indicates a minimum duration of audio content and a maximum duration of audio content; identifying a group of candidate audio content shows based at least on whether category associated with each show in the group of candidate audio content shows matches the category selected via the first user interface; selecting a subset of shows of the group of candidate audio content shows; identifying a group of candidate episodes associated with the subset of shows; selecting a subset of episodes of the group of candidate episodes based at least on whether a duration of each episode in the subset of episodes is greater than the minimum duration and less than the maximum duration corresponding to the duration selected via the second user interface; ranking the subset of episodes; and causing indications of the subset of episodes to be presented in a third user interface presented on the user device, wherein the indications of the subset of episodes are presented based on the ranking.

In accordance with some embodiments of the disclosed subject matter, a system for presenting audio content is provided, the system comprising: means for causing a first user interface to be presented on a user device that indicates a plurality of categories of audio content; means for receiving, via the first user interface, an indication of a selected category of the plurality of categories of audio content; in response to receiving the indication of the selected category via the first user interface, means for causing a second user interface to be presented on the user device that indicates a plurality of durations of audio content; means for receiving, via the second user interface, an indication of a selected duration of audio content, wherein the selected duration indicates a minimum duration of audio content and a maximum duration of audio content; means for identifying a group of candidate audio content shows based at least on whether category associated with each show in the group of candidate audio content shows matches the category selected via the first user interface; means for selecting a subset of shows of the group of candidate audio content shows; means for identifying a group of candidate episodes associated with the subset of shows; selecting a subset of episodes of the group of candidate episodes based at least on whether a duration of each episode in the subset of episodes is greater than the minimum duration and less than the maximum duration corresponding to the duration selected via the second user interface; means for ranking the subset of episodes; and means for causing indications of the subset of episodes to be presented in a third user interface presented on the user device, wherein the indications of the subset of episodes are presented based on the ranking.

### BRIEF DESCRIPTION OF THE DRAWINGS

Various objects, features, and advantages of the disclosed subject matter can be more fully appreciated with reference to the following detailed description of the disclosed subject matter when considered in connection with the following drawings, in which like reference numerals identify like elements.

FIGS. 1A-1D show examples of user interfaces for selecting categories of content and presenting indications of identified content in accordance with some embodiments of the disclosed subject matter.

FIG. 2 shows an example of a process for identifying and curating content in accordance with some embodiments of the disclosed subject matter.

FIG. 3 shows a schematic diagram of an illustrative system suitable for implementation of mechanisms described herein for identifying and curating content in accordance with some embodiments of the disclosed subject matter.

FIG. 4 shows a detailed example of hardware that can be used in a server and/or a user device of FIG. 3 in accordance with some embodiments of the disclosed subject matter.

### DETAILED DESCRIPTION

In accordance with various embodiments, mechanisms (which can include methods, systems, and media) for identifying and curating content are provided.

In some embodiments, the mechanisms described herein can identify content to be recommended to a user of a user device. For example, in some embodiments, the identified content can be spoken audio content, such as podcast shows or episodes, and/or any other suitable type of spoken audio content. Note that, although the mechanisms described herein are generally related to identifying spoken audio content, this is merely illustrative and any suitable type of content can be identified using the mechanisms described herein, such as other types of audio content (e.g., music, radio shows, and/or any other suitable type of audio content) and/or video content (television shows, videos, movies, and/or any other suitable type of video content).

It should also be noted that, although the embodiments described herein generally relate to full-length, short form feed items from podcast-RSS feeds, this is merely illustrative. In some embodiments, an audio segment of a full-length audio item can be selected for presentation. In this example, the audio segment can be selected based on an audio analysis of the full-length audio item (e.g., to determine an appropriate starting point and an appropriate end point). In another example, indications of the audio segment or segments corresponding to a full-length audio item can be provided by a content creator.

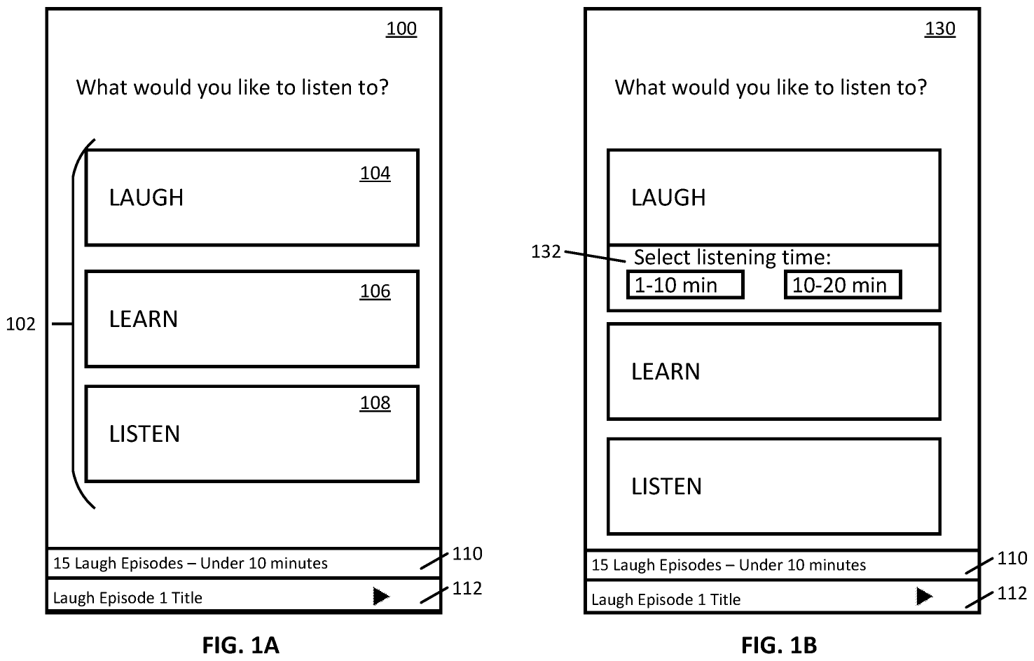

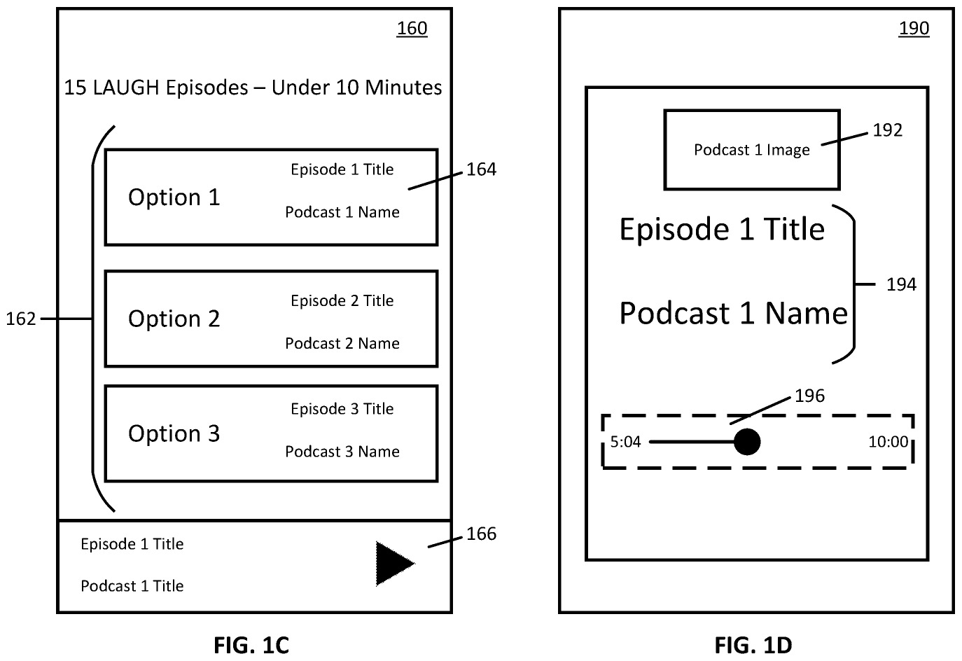

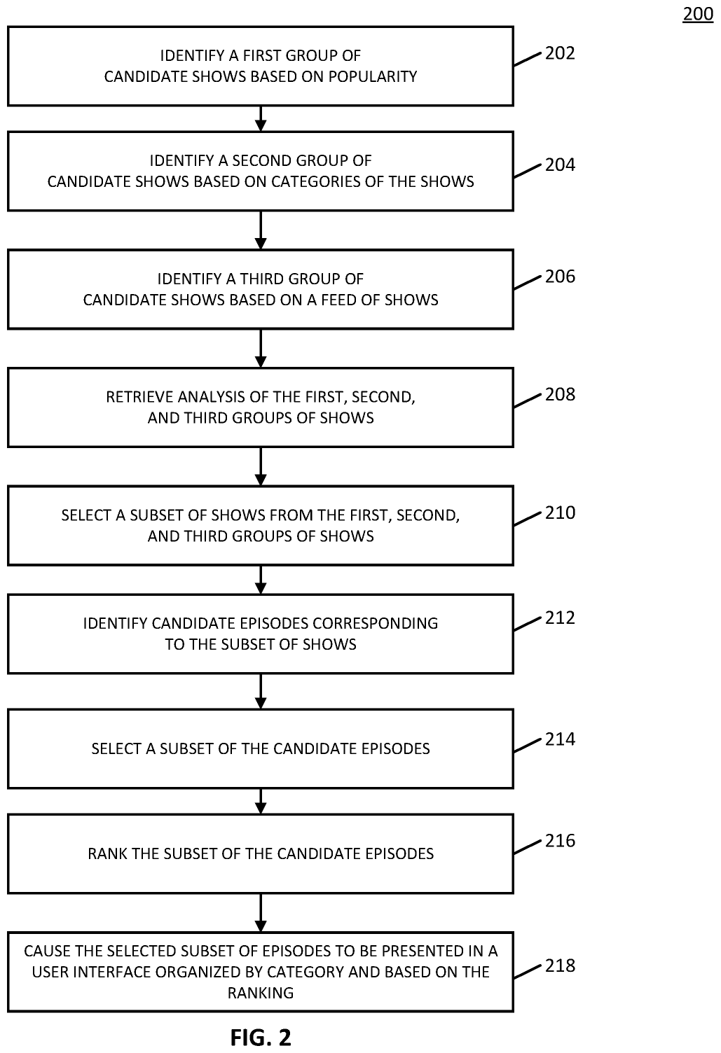

In some embodiments, the mechanisms described herein can cause the recommended content to be presented within a user interface on a user device. Additionally, in some embodiments, the mechanisms can cause a series of user interfaces to be presented on a user device that can be used to select a category of content desired by a user (e.g., a laugh content category, a learn content category, and a listen content category) and/or a duration of content desired by a user (e.g., 1 minute to 10 minutes, 10 minutes to 20 minutes, etc.). For example, in some embodiments, the mechanisms can cause a first user interface to be presented that indicates different categories of content (e.g., content related to comedy, content related to educational material, and/or any other suitable types of categories), as shown in and described below in connection with FIG. 1A. As another example, in some embodiments, in response to selecting a category of content, the mechanisms can cause a second user interface to be presented that indicates available durations of content items (e.g., less than ten minutes, between ten and twenty minutes, and/or any other suitable durations) that can be selected by a user of the second user interface, as shown in and described below in connection with FIG. 1B. As yet another example, in some embodiments, in response to selecting a duration of a content item, the mechanisms can cause a third user interface to be presented that indicates available episodes of content or available content items that have been selected based on a selected category, a selected content duration, and/or any other suitable information or criteria, as shown in and described below in connection with FIG. 1C. In some embodiments, available episodes of content can be presented based on a ranking of the available episodes, as described below in connection with FIG. 2.

In some embodiments, the mechanisms described herein can identify content to be recommended using any suitable technique or combination of techniques. For example, in some embodiments, the mechanisms can identify a group of candidate shows (e.g., podcast episodes and/or any other suitable type of show) based on any suitable information or factors, such as popularity, a category of the candidate shows, and/or any other suitable information or factors. In some embodiments, the mechanisms can select shows from a group of candidate shows based on any suitable factors, such as whether a particular show tends to include evergreen content that is relevant to a listener of the show after a predetermined duration of time has elapsed (e.g., relevant after a month, relevant after a year, and/or any other suitable duration of time), whether a particular show is related to categories or topics that are of interest to a particular user, and/or any other suitable factors. In some embodiments, the mechanisms can identify episodes associated with selected shows, and can rank the identified episodes in any suitable manner. In some embodiments, the mechanisms can then recommend the identified episodes based on the ranking, for example, by presenting indications of the identified episodes within a user interface, as shown in and described below in connection with FIG. 1C. More detailed techniques for identifying content are shown in and described below in connection with FIG. 2.

Turning to FIGS. 1A-1D, examples of user interfaces for presenting curated content are shown in accordance with some embodiments of the disclosed subject matter. Note that, in some embodiments, the curated content can correspond to any suitable type of content. For example, in some embodiments, the content can correspond to audio content, such as a podcast (e.g., a podcast episode in its entirety, a portion or segment of a podcast episode, etc.), a radio show, and/or any other suitable type of audio content. As another example, in some embodiments, the content can correspond to video content, such as a podcast episode that includes video content, and/or any other suitable type of video content.

FIG. 1A shows an example 100 of a user interface for presenting categories of content in accordance with some embodiments of the disclosed subject matter. As illustrated, in some embodiments, user interface 100 can include a group of categories 102. In some embodiments, group of categories 102 can include any suitable individual categories, such as categories 104, 106, and/or 108. In some embodiments, each individual category can correspond to any suitable category or topic associated with content, such as humor (e.g., a “laugh” category 104, and/or any other suitable category), educational (e.g., a “learn” category 106, and/or any other suitable category), a miscellaneous category (e.g., a “listen” category 108, and/or any other suitable category), and/or any other suitable categories or topics. Note that, although three categories are shown in user interface 100 of FIG. 1A, in some embodiments, any suitable number of categories (e.g., one, five, ten, and/or any other suitable number) corresponding to any suitable categories or topics can be included in user interface 100.

Additionally, in some embodiments, user interface 100 can include layers 110 and 112 that correspond to available episodes for a particular category of group of categories 102 and a player window for a first available episode in the particular category of group of categories 102, respectively. For example, as shown in FIG. 1A, layer 110 can be a user interface layer that corresponds to category 104 (e.g., a “laugh” category). As a more particular example, as shown in FIG. 1A, layer 110 can indicate a number of episodes that have been identified within category 104 and/or a number of identified episodes in category 104 that are within a particular time duration (e.g., under ten minutes, and/or any other suitable duration). Note that, in some embodiments, layer 110 can correspond to any suitable category of group of categories 102, such as a first listed category (e.g., a “laugh” category as shown in FIG. 1A, and/or any other suitable category). As another example, as shown in FIG. 1A, layer 112 can be a user interface layer that corresponds to a player window for playing a first available identified episode within category 104. As a more particular example, in some embodiments, layer 112 can include any suitable information, such as a name of the first available identified episode, a show or channel associated with the first available identified episode, any suitable user interface controls to manipulate playback of the episode (e.g., a play button, a rewind button, a fast-forward button, a volume control, and/or any other suitable controls), and/or any other suitable information. Note that, in some embodiments, each of layer 110 and/or layer 112 can be selectable. For example, in some embodiments, selection of layer 110 can cause user interface 160 as shown in and described below in connection with FIG. 1C to be presented. As another example, in some embodiments, selection of layer 112 can cause user interface 190 as shown in and described below in connection with FIG. 1D to be presented. In some embodiments, selection of one of layer 110 and/or 112 can cause user interfaces 160 and/or 190, respectively, to be presented in any suitable manner (e.g., to slide up from a bottom portion of a display on which user interface 100 is being presented, to slide in from a left or right portion of a display on which user interface 100 is being presented, and/or to appear in any other suitable manner).

FIG. 1B shows an example 130 of a user interface for allowing a user of user interface 130 to select a duration of content associated with a selected category of content in accordance with some embodiments of the disclosed subject matter. In some embodiments, user interface 130 can be presented in response to determining that a user of user interface 100 has selected a category from group of categories 102, such as category 104. As illustrated, user interface 130 can include an option 132 for selecting a duration of recommended content. In some embodiments, option 132 can include a group of durations, such as 1-10 minutes, 10-20 minutes, 20-30 minutes, and/or any other suitable durations. In some embodiments, each duration in a group of durations can be a selectable input that, when selected, causes recommended content to be selected to include content having a duration corresponding to the selected duration.

FIG. 1C shows an example 160 of a user interface for presenting identified episodes corresponding to a selected category and a selected episode duration in accordance with some embodiments of the disclosed subject matter. In some embodiments, user interface 160 can be presented in response to a user of user interface 130 selecting a duration for content. For example, in some embodiments, episodes indicated in user interface 160 can have a duration corresponding to the duration selected via user interface 130.

As illustrated, in some embodiments, user interface 160 can include a group of episodes 162, which can include any suitable number of individual episodes, such as episode 164. In some embodiments, an individual episode can be an episode of any suitable type of content, such as a podcast. In some embodiments, episode 164 can include any suitable content or information, such as a title of the episode, a name of a podcast or channel associated with the episode, a duration of the episode, an image associated with the podcast or the episode, a date the episode was created or recorded, and/or any other suitable type of content or information. Note that, in some embodiments, episodes included in group of episodes 162 can be limited in any suitable manner. For example, in some embodiments, only a predetermined number of episodes (e.g., one, two, and/or any other suitable number) associated with a particular show can be presented within group of episodes 162.

Additionally, note that, in some embodiments, individual episodes presented within group of episodes 162 can be ranked based on any suitable criteria, such as a popularity of the episode or a show associated with the episode, a likelihood that a user of the user device presenting user interface 160 would enjoy the episode (e.g., based on consumption history), audio quality of the episode, whether the episode contains controversial content, whether the episode includes a pre-roll advertisement and/or any other suitable type of advertisement, whether a human evaluator has provided a score corresponding to the episode, and/or any other suitable criteria. Additional details relating to ranking of episodes are described below in more detail in connection with block 216 of FIG. 2.

In some embodiments, user interface 160 can include layer 166, which can correspond to a player window for playing a particular episode in group of episodes 162. For example, as shown in FIG. 1C, layer 166 can correspond to a player window for playing a first identified episode, such as episode 164, in group of episodes 162. In some embodiments, layer 166 can include any suitable information or user interface controls, such as a name of the episode, a name of a show or channel of the episode, user interface controls for manipulating playback of the episode (e.g., a play button, a pause button, a rewind button, a fast-forward button, a volume control, and/or any other suitable controls). In some embodiments, selection of layer 166 can cause a user interface that includes a player window for playing the episode to be presented, such as user interface 190 of FIG. 1D. In some embodiments, selection of layer 166 can cause the user interface to be presented in any suitable manner (e.g., to slide in from a bottom portion of a display on which user interface 160 is presented, and/or in any other suitable manner).

In some embodiments, user interface 160 can include any other suitable content or user interface controls. For example, in some embodiments, user interface 160 can include a selectable input that, when selected, causes additional recommendations or recommended content items to be presented. As another example, in some embodiments, user interface 160 can include a selectable input to change a selected category of content to a different category of content. As yet another example, in some embodiments, user interface 160 can include a selectable input to change a selected duration of content to a different duration of content.

Turning to FIG. 1D, an example 190 of a user interface for presenting a player window for presenting a particular episode (e.g., a selected episode, a first identified episode in a group of episodes, a first ranked episode in a group of episodes, and/or any other suitable episode) is shown in accordance with some embodiments of the disclosed subject matter. In some embodiments, user interface 190 can include any suitable content, such as an image 192, information 194, and/or controls 196.

In some embodiments, image 192 can be any suitable image associated with the episode being presented in the player window. For example, in some embodiments, image 192 can be an image associated with a channel or show corresponding to the episode (e.g., an icon of the channel or show, and/or any other suitable image). Note that, in some embodiments, image 192 can be omitted.

In some embodiments, information 194 can include any suitable information relating to the episode being presented in the player window. For example, in some embodiments, information 194 can include a name of the episode, a number associated with the episode, a name of a channel or show that produced the episode, a ranking associated with the episode or the show, and/or any other suitable information. Additionally or alternatively, in some embodiments, information 194 can include any suitable user interface controls to interact with the episode and/or a service associated with providing the episode. For example, in some embodiments, information 194 can include one or more user interface controls to provide an endorsement indication or rate the episode (e.g., a thumbs-up button, a thumbs-down button, a series of stars to rate the episode, and/or any other suitable user interface controls). As another example, in some embodiments, information 194 can include a selectable input that, when selected, can allow a user of user interface 190 to provide a comment or message associated with the episode or the show (e.g., a comment to be presented as feedback on the episode or show, a comment or message to chat with other listeners of the episode or show, and/or any other suitable comment or message).

In some embodiments, controls 196 can include any suitable user interface controls for manipulating playback of the episode within the player window. For example, in some embodiments, controls 196 can include a current timestamp indicator, as shown in FIG. 1D. As a more particular example, in some embodiments, the current timestamp indicator can indicate a current timestamp associated with presentation of the episode (e.g., a duration of the episode that has elapsed, and/or any other suitable timestamp), a duration of the episode, and/or any other suitable information. As another example, in some embodiments, controls 196 can include a play button, a pause button, a volume control, a rewind button, a fast-forward button, and/or any other suitable controls.

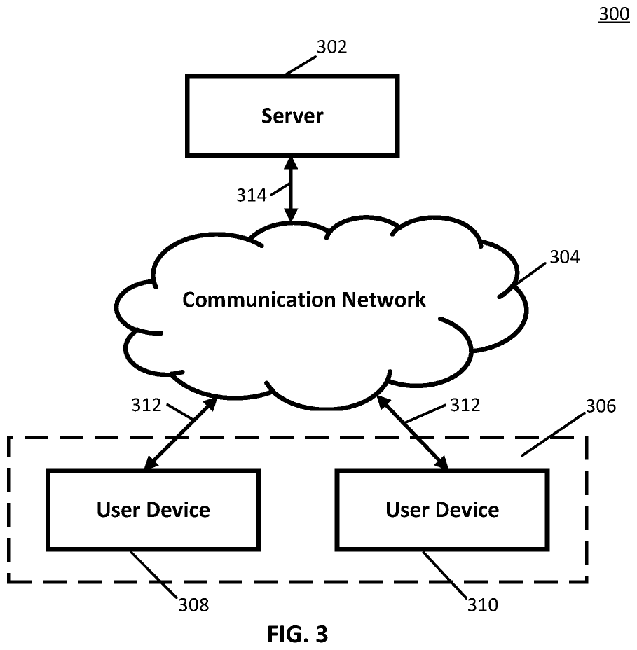

Turning to FIG. 2, an example 200 of a process for identifying and curating content is shown in accordance with some embodiments of the disclosed subject matter. In some embodiments, blocks of process 200 can be executed on a server, such as server 302 as shown in and described below in connection with FIG. 3. For example, in some embodiments, the server can be a server which stores recommended content and/or provides recommendations of content to a user of a user device. Note that, in some embodiments, process 200 can be used to identify content to be recommended to a particular user of a user device, for example, by identifying content likely to be enjoyed by the user.

Process 200 can begin at 202 by identifying a first group of candidate shows based on a popularity of shows. In some embodiments, shows can include any suitable type of media content, such as podcasts, radio shows, television shows, and/or any other suitable type of shows. In some embodiments, process 200 can identify the first group of candidate shows using any suitable information. For example, in some embodiments, process 200 can identify or retrieve a ranking of shows and can identify the first group of candidate shows as the first N (e.g., the first 100, the first 200, the first 250, and/or any other suitable number) shows of the ranking. In some such embodiments, a ranking of shows can be based on any suitable type of metric, such as a number of subscribers of the show, a number of times a link to a show or an episode of the show has been shared (e.g., via a social networking service, via a message, and/or in any other suitable manner), a number of times episodes of the show have been downloaded, a number of episodes that have been produced in connection with the show, a frequency of episodes connected with the show (e.g., a new episode every week, a new episode every month, and/or any other suitable frequency), and/or based on any other suitable metric.

At 204, process 200 can identify a second group of candidate shows based on categories associated with the shows. In some embodiments, process 200 can identify the second group of candidate shows as shows that are associated with any suitable categories or topics. For example, in some embodiments, the categories or topics can include humor or comedy, history, science, technology, interviews, and/or any other suitable categories or topics. In some embodiments, any suitable number of shows (e.g., 100, 300, 500, and/or any other suitable number) corresponding to any suitable number of categories (e.g., three, five, ten, twenty, and/or any other suitable number) can be identified. In some embodiments, one or more categories and/or topics can be assigned to a show in any suitable manner. For example, in some embodiments, a category or topic can be assigned to a show based on one or more keywords associated with a show (e.g., one or more keywords specified by a creator of the shows, and/or by any other suitable entity). As another example, in some embodiments, a category or a topic of a show can be identified using any suitable technique or combination of techniques, such as by using a Wernicke index, and/or in any other suitable manner.

Note that, in some embodiments, the second group of candidate shows can be identified to match a category associated with a selected category or selected categories by the user of the user device. For example, in an instance where a user of user interface 100 as shown in and described above in connection with FIG. 1A selects a comedy category or a “laugh” category (as shown in FIG. 1A), process 200 can identify the second group of candidate shows to include shows associated with a comedy or humor category. As another example, in an instance where a user of user interface 100 as shown in and described above in connection with FIG. 1A selects an educational category or a “learn” category (as shown in FIG. 1A), process 200 can identify the second group of candidate shows to include shows associated with any suitable categories, such as science, technology, history, art, and/or any other suitable categories.

At 206, process 200 can identify a third group of candidate shows based on one or more feeds (e.g., RSS feeds, and/or any other suitable feeds) of shows. For example, in some embodiments, process 200 can access any suitable RSS feed of podcasts or other shows, and can identify new episodes of existing shows or new shows. In some embodiments, process 200 can extract any suitable information related to a new episode or a new show, such as a Uniform Resource Locator (URL) associated with the new episode or the new show, keywords associated with the new episode or the new show, and/or any other suitable information.

At 208, process 200 can retrieve analysis of shows in the first, second, and third groups of candidate shows. In some embodiments, the analysis of the shows can be performed by any suitable entity, such as human evaluators, and/or any other suitable entity. In some embodiments, an analysis of a show can indicate any suitable information about a show. For example, in some embodiments, an analysis of a show can indicate whether the show is associated with episodic content or serial content. As another example, in some embodiments, an analysis of a show can indicate whether the shows typically includes evergreen content (e.g., content that is generally relevant at a future time) or whether the show will become irrelevant at a predetermined future time (e.g., is related to news, is related to a particular sporting event or other event, and/or any other suitable type of content). As a more particular example, in some embodiments, process 200 can determine whether a show is likely to include evergreen content or whether the show is likely to include news-related content based on whether a tag or keyword associated with the show includes “news.” As yet another example, in some embodiments, the analysis can indicate one or more tags for association with a show (e.g., select five out of the presented tags that represent the content in the given episode). As a more particular example, in some embodiments, the analysis can indicate tags that each specify a category or topic associated with the show. As another more particular example, in some embodiments, a tag can indicate that the show or episodes of the show are likely to include particular types of controversial content (e.g., mature language, related to particular topics, and/or any other suitable type of controversial content). As yet another more particular example, in some embodiments, the analysis can indicate whether previously assigned categories or topics associated with a show are accurate. As still another example, in some embodiments, the analysis can indicate whether episodes of the show are likely to include advertisements (e.g., pre-roll advertisements, interstitial advertisements, and/or any other suitable types of advertisements). As still another example, in some embodiments, the analysis can indicate whether an episode of the show is likely to include one or more standalone segments that can be viewed or listened to individually without viewing the rest of an episode of the show. As a more particular example, in some embodiments, the analysis can indicate that episodes of the show typically have an opening monologue. As another more particular example, in some embodiments, the analysis can indicate that episodes of the show typically feature an interview in a middle portion of an episode. In some such embodiments, the analysis of the show can indicate a time duration during the episode likely to include a standalone segment (e.g., from 5:00-10:00, from 10:00-30:00, and/or any other suitable time duration), and/or a typical duration of the standalone segment (e.g., ten minutes, twenty minutes, and/or any other suitable duration).

At 210, process 200 can select a subset of shows from the first, second, and third groups of shows. In some embodiments, process 200 can select the subset of shows based on any suitable information, such as information associated with each show determined during identification of the first, second, and third groups of shows and/or an analysis of shows as described above in connection with block 208. For example, in some embodiments, process 200 can select shows from the first, second, and third groups of shows that feature episodic content rather than serial content (e.g., that do not require viewing or listening to one episode before another). As another example, in some embodiments, process 200 can select shows from the first, second, and third groups of shows that feature evergreen content (e.g., shows that are not limited in their relevance based on date). As yet another example, in some embodiments, process 200 can select shows that are associated with more than a predetermined number of episodes (e.g., more than five, more than ten, and/or any other suitable number). As still another example, in some embodiments, process 200 can select shows that are likely to include standalone segments of a particular duration (e.g., less than ten minutes, less than twenty minutes, and/or any other suitable duration).

In some embodiments, process 200 can select the subset of shows based on categories or topics associated with the shows. For example, in some embodiments, process 200 can select shows that are associated with particular categories or topics (e.g., comedy, interviews, true crime, science, technology, and/or any other suitable categories or topics). As a more particular example, in some embodiments, process 200 can select shows that are assigned to a category or categories associated with a category selected by the user of the user device, such as via user interface 100 as shown in and described above in connection with FIG. 1A.

Note that, in some embodiments, process 200 can select the subset of shows based on user preferences of a particular user of a user device. For example, in some embodiments, process 200 can select shows that are associated with particular categories or topics the user of the user device has previously viewed or listened to and/or has previously indicated enjoyment of (e.g., by listening to multiple episodes associated with the show, by highly rating the show in any suitable manner, and/or in any other suitable manner). As a more particular example, in some embodiments, process 200 can select a relatively higher percentage of shows that are associated with a particular category or topic relative to shows that are associated with other categories or topics based on a previous viewing history of the user of the user device. As another example, in some embodiments, process 200 can select shows that have featured a guest related to another show the user of the user device has previously viewed or listened to and/or has previously indicated enjoyment of (e.g., a guest that has appeared on both shows, a guest that has created their own show after being interviewed or appearing as a guest on another show, and/or any other suitable guest).

At 212, process 200 can identify candidate episodes corresponding to the subset of shows. For example, in an instance where the subset of shows includes thirty shows, process 200 can identify any suitable number of episodes associated with each of the thirty shows. Note that, in some embodiments, a different number of episodes can be identified for each show. In some embodiments, the candidate episodes can be identified in any suitable manner. For example, in some embodiments, process 200 can identify episodes associated with a particular show in the subset of shows using an RSS feed associated with the show. Note that, in some embodiments, the candidate episodes can be limited in any suitable manner, for example, to episodes that have aired and/or were created within a predetermined duration of time (e.g., within the last month, within the last year, and/or any other suitable duration).

At 214, process 200 can select a subset of the candidate episodes. In some embodiments, process 200 can select the subset of the candidate episodes based on any suitable information and using any suitable technique(s). For example, in some embodiments, process 200 can select the subset of the candidate episodes to exclude episodes that are teaser episodes for other episodes. As another example, in some embodiments, process 200 can select the subset of the candidate episodes to include episodes that are within a predetermined duration (e.g., less than ten minutes, between ten minutes and twenty minutes, and/or any other suitable duration). As a more particular example, in some embodiments, process 200 can select episodes that have a duration corresponding to a duration selected by the user of the user device via a user interface such as user interface 130, as shown in and described above in connection with FIG. 1B. As yet another example, in some embodiments, process 200 can select the subset of the candidate episodes to exclude episodes that feature news-related content (e.g., that discuss a news event, and/or any other suitable news-related content), thereby excluding episodes that are relevant for a particular duration of time after recording. As still another example, in some embodiments, process 200 can select episodes that have a relatively high audio quality. As still another example, in some embodiments, process 200 can select episodes that were identified by human evaluators in any suitable manner (e.g., based on general popularity, based on having good audio quality, based on being associated with particularly accurate keywords or categories, and/or identified in any other suitable manner).

Note that, in some embodiments, in instances where a particular show is likely to feature one or more standalone segments within an episode, process 200 can identify and create an episode that features a standalone segment (e.g., a monologue, an interview, and/or any other suitable standalone segment). In some embodiments, process 200 can identify and create the episode featuring the standalone segment in any suitable manner. For example, in some embodiments, process 200 can trim an existing episode to a portion of the episode that features only the standalone segment and can then store the trimmed portion as a new episode. In some such embodiments, the new episode can then be included in the subset of the candidate episodes.

Additionally or alternatively to selecting a subset of candidate episodes by excluding one or more episodes (e.g., an exclude operator to exclude episodes containing news-related content, episodes that are deemed to be long in duration, etc.), process 200 can select a subset of candidate episodes by determining whether an episode is blacklisted or otherwise indicated as not being suitable for selection as a candidate episode. For example, in some embodiments, process 200 can determine whether an episode is included in a blacklist of episodes. In another example, in some embodiments, process 200 can determined whether an episode and episode-related information (e.g., channel information, creator information, episode content information, show information, appearance information relating to a person participating in an episode, etc.) is included in one or more blacklists, such as user-created blacklists or administrator-created blacklists. In response to determining that an episode or episode-related information corresponds with an entry on one or more blacklists, process 200 can remove the episode from consideration as a candidate episode.

It should be noted that, in some embodiments, an episode can be blacklisted during certain times of day and/or on certain days, but may not be blacklisted for other times and/or days. For example, an episode containing adult-oriented content may be blacklisted from being presented to a user during daytime hours based on parental controls. In another example, an episode containing a particular type of content may be blacklisted from being presented to a user during weekdays based on user preferences (e.g., particular topics for presentation on the weekdays as opposed to particular topics for presentation on the weekends).

In continuing with the example described above, process 200 can inhibit such an episode from being presented in a user interface to the user. For example, process 200 can ensure that an episode associated with one or more blacklists is not presented in one or more user interfaces to the user. In another example, process 200 can select a subset of candidate episodes by excluding one or more episodes described above and then determine whether one or more candidate episodes in the subset of candidate episodes should be removed based on one or more blacklists.

At 216, process 200 can rank the subset of the candidate episodes. In some embodiments, process 200 can rank the subset of the candidate episodes in any suitable manner and based on any suitable information. For example, in some embodiments, process 200 can rank the subset of the candidate episodes based on a popularity metric associated with a show corresponding to each episode and/or based on a popularity metric associated with the episode. As a more particular example, in some embodiments, a popularity metric can be based on any suitable information or combination of information, such as a number of subscriptions to the show, a number of times a show and/or an episode has been downloaded to a user device, a number of times links to a show have been shared (e.g., on a social networking service, and/or in any other suitable manner), and/or any other suitable information indicating popularity. As another example, in some embodiments, process 200 can rank the subset of the candidate episodes based on a likelihood that a particular user of a user device will enjoy the episode. As a more particular example, in some embodiments, process 200 can determine a likelihood that the user will enjoy the episode based on previous listening history (e.g., how relevant a category or topic of the episode is to categories or topics of previously listened to episodes, whether the episode is associated with a show the user has previously listened to, a number of times the user has previously listened to other episodes associated with the show, and/or any other suitable information related to listening history). As yet another example, in some embodiments, process 200 can rank the subset of the candidate episodes based on an audio quality of each episode. As still another example in some embodiments, process 200 can rank the subset of the candidate episodes based on whether each episode has been identified by a human evaluator, such that episodes that have been identified by human evaluators are ranked higher than other episodes.

In a more particular example, process can rank episodes within the subset of human evaluator-curated episodes and the subset of automatically-curated episodes. For example, in some embodiments, the human evaluator-curated episodes can be used as the only source for the audio items presented within a particular portion of search results in the user interfaces described above in FIGS. 1A-1D (e.g., only human evaluator-curated episodes in the top five feed items including after updating the subsets of content items and rankings of those content items). In continuing this example, the remaining content items can be selected from the subset of human evaluator-curated episodes and the subset of automatically-curated episodes.

In some embodiments, each human evaluator-curated episode can have a score that is normalized to a number between 0 and 100. For example, the score for a particular human evaluator-curated episode can be calculated based on how the content item was placed in the subset. In a more particular example, for human evaluator-curated episodes promoted by a trusted listener or a user having a particular number of individual binary votes, the score can be calculated as a percentage of listens with a positive vote or indication of endorsement (e.g., a “thumbs up” selected indicator) provided that the episode has more than five positive endorsements and the total percentage is at least fifty percent. Otherwise, if the human evaluator-curated episode has less than five positive endorsements, a score of 50 can be assigned for the human evaluator-curated episode provided that the total percentage is at least fifty percent.

In a more particular example, the scores calculated for four different episodes with different listener characteristics can be represented as follows:

| | | | | |
|---|---|---|---|---|
| Episode 1 | 14 total listens | 6 thumbs up | 6 thumbs down | Score: 0 |
| Episode 2 | 11 total listens | 7 thumbs up | 3 thumbs down | Score: 64 |
| Episode 3 | 3 total listens | 2 thumbs up | 1 thumbs down | Score: 50 |
| Episode 4 | 4 total listens | 1 thumbs up | 2 thumbs down | Score: 0 |

It should be noted that, in some embodiments, a score for a human evaluator-curated episode used by the mechanisms described herein can be determined based on a combination of episode score from a trusted listener, the audio quality, the content quality, and the popularity of the show from which the episode originates.

In some embodiments, each automatically curated episode can also have a score that is normalized to a number between 0 and 100. For example, the score for a particular automatically curated episode can be calculated based on how the content item was placed in the subset. In a more particular example, for a whitelisted show having episodes in both the subset of human evaluator-curated episodes and the subset of automatically curated episodes, the score can be an average of the episode-level scores generated for that show from the human evaluator-curated episodes. In continuing this example, for shows that do not have episodes in the subset of human evaluator-curated episodes, process 200 can assign the rank or score of 0, thereby causing the episode to be provided back for further analysis.

Although the embodiments described herein generally mention that a score for an automatically curated episode can be an average of the episode-level scores generated for that show from the human evaluator-curated episodes, this is merely illustrative. In some embodiments, episode-level scores can be weighted based on, for example, a number of episodes scored by a human evaluator. In some embodiments, episode-level scores can be excluded based on, for example, episode-level scores received from a human evaluator that has not provided scores for more than a threshold number of episodes.

At 218, process 200 can cause the selected subset of episodes to be presented in a user interface organized by category and by the ranking of the episodes. An example of such a user interface is shown in and described above in connection with FIG. 1C. As shown in and described above in connection with FIG. 1C, in some embodiments, process 200 can cause a group of episodes of the subset of episodes to be presented in the user interface in response to determining that episodes of the group of episodes are associated with a particular category or topic (e.g., a “laugh” category as shown in and described above in connection with FIG. 1C). For example, as shown in FIG. 1C, episodes associated with a “laugh” category are shown, and, in some embodiments, process 200 can cause episodes associated with a comedy category to be presented in such a user interface. Additionally, as shown in and described above in connection with FIGS. 1B and 1C, process 200 can cause episodes to be presented in the user interface in response to determining that a duration of each episode corresponds to a duration selected by a user (e.g., less than ten minutes, between ten and twenty minutes, and/or any other suitable duration). In some embodiments, process 200 can cause the selected subset of episodes to be presented in an order based on the ranking, for example, with a highest ranked episode appearing first in a list of episodes. Note that, in some embodiments, any suitable number of episodes (e.g., one, two, five, ten, and/or any other suitable number) can be indicated in the user interface.

In some embodiments, selection of a particular episode within the user interface can cause the episode to begin playing on a user device that is presenting the user interface. For example, in some embodiments, the episode can begin playing within a podcast player window on the user device, and/or in any other suitable manner.

Turning to FIG. 3, an example 300 of hardware for identifying and curating content that can be used in accordance with some embodiments of the disclosed subject matter is shown. As illustrated, hardware 300 can include a server 302, a communication network 304, and/or one or more user devices 306, such as user devices 308 and 310.

Server 302 can be any suitable server(s) for storing information, data, media content, and/or any other suitable type of content. In some embodiments, server 302 can identify audio content to be recommended to a user of user device 306. For example, in some embodiments, server 302 can identify audio content shows (e.g., podcasts, and/or any other suitable types of shows) and/or episodes of particular shows and can categorize the identified shows for recommendation to the user, as shown in and described above in connection with FIGS. 1 and 2.

Communication network 304 can be any suitable combination of one or more wired and/or wireless networks in some embodiments. For example, communication network 304 can include any one or more of the Internet, an intranet, a wide-area network (WAN), a local-area network (LAN), a wireless network, a digital subscriber line (DSL) network, a frame relay network, an asynchronous transfer mode (ATM) network, a virtual private network (VPN), and/or any other suitable communication network. User devices 306 can be connected by one or more communications links (e.g., communications links 312) to communication network 304 that can be linked via one or more communications links (e.g., communications links 314) to server 302. The communications links can be any communications links suitable for communicating data among user devices 306 and server 302 such as network links, dial-up links, wireless links, hard-wired links, any other suitable communications links, or any suitable combination of such links.

User devices 306 can include any one or more user devices suitable for presenting indications of recommended audio content and/or listening to audio content. For example, in some embodiments, user devices 306 can include a television, speakers, a mobile phone, a tablet computer, a media player, a desktop computer, a vehicle entertainment system, a wearable computer, and/or any other suitable type of user device.

Although server 302 is illustrated as one device, the functions performed by server 302 can be performed using any suitable number of devices in some embodiments. For example, in some embodiments, multiple devices can be used to implement the functions performed by server 302.

Although two user devices 308 and 310 are shown in FIG. 3 to avoid over-complicating the figure, any suitable number of user devices, and/or any suitable types of user devices, can be used in some embodiments.

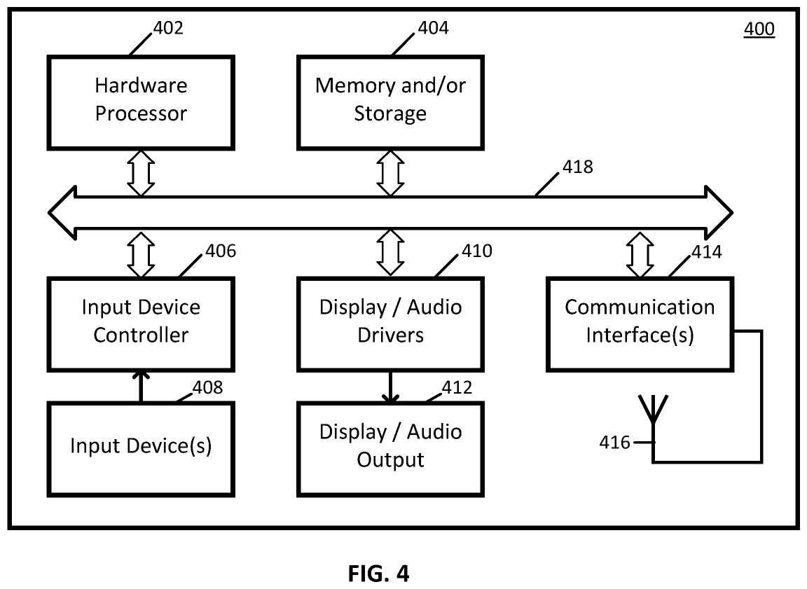

Server 302 and user devices 306 can be implemented using any suitable hardware in some embodiments. For example, in some embodiments, devices 302 and 306 can be implemented using any suitable general-purpose computer or special-purpose computer. For example, a mobile phone may be implemented using a special-purpose computer. Any such general-purpose computer or special-purpose computer can include any suitable hardware. For example, as illustrated in example hardware 400 of FIG. 4, such hardware can include hardware processor 402, memory and/or storage 404, an input device controller 406, an input device 408, display/audio drivers 410, display and audio output circuitry 412, communication interface(s) 414, an antenna 416, and a bus 418.

Hardware processor 402 can include any suitable hardware processor, such as a microprocessor, a micro-controller, digital signal processor(s), dedicated logic, and/or any other suitable circuitry for controlling the functioning of a general-purpose computer or a special-purpose computer in some embodiments. In some embodiments, hardware processor 402 can be controlled by a server program stored in memory and/or storage of a server, such as server 302. For example, in some embodiments, the server program can cause hardware processor 402 to identify shows of audio content, categorize shows of audio content, identify episodes associated with particular shows of audio content, rank identified episodes, cause indications of recommended episodes to be presented on a user device, and/or perform any other suitable functions. In some embodiments, hardware processor 402 can be controlled by a computer program stored in memory and/or storage 404 of user device 306. For example, the computer program can cause hardware processor 402 to present indications of recommended audio content, cause a selected audio content episode to be played back on user device 306, and/or perform any other suitable functions.

Memory and/or storage 404 can be any suitable memory and/or storage for storing programs, data, and/or any other suitable information in some embodiments. For example, memory and/or storage 404 can include random access memory, read-only memory, flash memory, hard disk storage, optical media, and/or any other suitable memory.

Input device controller 406 can be any suitable circuitry for controlling and receiving input from one or more input devices 408 in some embodiments. For example, input device controller 406 can be circuitry for receiving input from a touchscreen, from a keyboard, from one or more buttons, from a voice recognition circuit, from a microphone, from a camera, from an optical sensor, from an accelerometer, from a temperature sensor, from a near field sensor, from a pressure sensor, from an encoder, and/or any other type of input device.

Display/audio drivers 410 can be any suitable circuitry for controlling and driving output to one or more display/audio output devices 412 in some embodiments. For example, display/audio drivers 410 can be circuitry for driving a touchscreen, a flat-panel display, a cathode ray tube display, a projector, a speaker or speakers, and/or any other suitable display and/or presentation devices.

Communication interface(s) 414 can be any suitable circuitry for interfacing with one or more communication networks (e.g., computer network 304). For example, interface(s) 414 can include network interface card circuitry, wireless communication circuitry, and/or any other suitable type of communication network circuitry.

Antenna 416 can be any suitable one or more antennas for wirelessly communicating with a communication network (e.g., communication network 304) in some embodiments. In some embodiments, antenna 416 can be omitted.

Bus 418 can be any suitable mechanism for communicating between two or more components 402, 404, 406, 410, and 414 in some embodiments.

Any other suitable components can be included in hardware 400 in accordance with some embodiments.

In some embodiments, at least some of the above described blocks of the process of FIG. 2 can be executed or performed in any order or sequence not limited to the order and sequence shown in and described in connection with the figures. Also, some of the above blocks of FIG. 2 can be executed or performed substantially simultaneously where appropriate or in parallel to reduce latency and processing times. Additionally or alternatively, some of the above described blocks of the process of FIG. 2 can be omitted.

In some embodiments, any suitable computer readable media can be used for storing instructions for performing the functions and/or processes herein. For example, in some embodiments, computer readable media can be transitory or non-transitory. For example, non-transitory computer readable media can include media such as non-transitory forms of magnetic media (such as hard disks, floppy disks, and/or any other suitable magnetic media), non-transitory forms of optical media (such as compact discs, digital video discs, Blu-ray discs, and/or any other suitable optical media), non-transitory forms of semiconductor media (such as flash memory, electrically programmable read-only memory (EPROM), electrically erasable programmable read-only memory (EEPROM), and/or any other suitable semiconductor media), any suitable media that is not fleeting or devoid of any semblance of permanence during transmission, and/or any suitable tangible media. As another example, transitory computer readable media can include signals on networks, in wires, conductors, optical fibers, circuits, any suitable media that is fleeting and devoid of any semblance of permanence during transmission, and/or any suitable intangible media.

Accordingly, methods, systems, and media for identifying and curating content are provided.

Although the invention has been described and illustrated in the foregoing illustrative embodiments, it is understood that the present disclosure has been made only by way of example, and that numerous changes in the details of implementation of the invention can be made without departing from the spirit and scope of the invention, which is limited only by the claims that follow. Features of the disclosed embodiments can be combined and rearranged in various ways.

What is claimed is:

1. A method for presenting audio content, the method comprising:
causing, using a hardware processor, a first user interface to be presented on a user device that indicates a plurality of categories of audio content;
receiving, via the first user interface, an indication of a selected category of the plurality of categories of audio content;
in response to receiving the indication of the selected category via the first user interface, causing a second user interface to be presented on the user device that indicates a plurality of durations of audio content;
receiving, via the second user interface, an indication of a selected duration of audio content, wherein the selected duration indicates a minimum duration of audio content and a maximum duration of audio content;
identifying a group of candidate audio content shows based at least on whether category associated with each show in the group of candidate audio content shows matches the category selected via the first user interface;
selecting a subset of shows of the group of candidate audio content shows;
identifying a group of candidate episodes associated with the subset of shows;
selecting a subset of episodes of the group of candidate episodes based at least on whether a duration of each episode in the subset of episodes is greater than the minimum duration and less than the maximum duration corresponding to the duration selected via the second user interface;
ranking the subset of episodes; and
causing indications of the subset of episodes to be presented in a third user interface presented on the user device, wherein the indications of the subset of episodes are presented based on the ranking.

2. The method of claim 1, wherein ranking the subset of episodes comprises determining a likelihood a user of the user device will enjoy each episode in the subset of episodes, wherein the ranking is based on the likelihood.

3. The method of claim 1, wherein the group of candidate audio content shows are identified based on a popularity of each show in the group of candidate audio content shows.

4. The method of claim 1, wherein the group of candidate audio content shows are identified based on whether episodes associated with each show in the group of candidate audio content shows are likely to be relevant to a user of the user device after a predetermined duration of time has elapsed.

5. The method of claim 1, further comprising:
for an episode included in the group of candidate episodes, identifying a portion of the episode, wherein the portion of the episode includes audio content of a particular type; and
generating a trimmed version of the episode that includes the identified portion of the episode, wherein the trimmed version of the episode is included in the subset of episodes.

6. The method of claim 1, wherein identifying the group of candidate episodes is based on an RSS feed associated with shows in the subset of shows.

7. A system for presenting audio content, the system comprising:
a memory; and
a hardware processor that, when executing computer executable instructions, is configured to:
cause a first user interface to be presented on a user device that indicates a plurality of categories of audio content;
receive, via the first user interface, an indication of a selected category of the plurality of categories of audio content;
in response to receiving the indication of the selected category via the first user interface, cause a second user interface to be presented on the user device that indicates a plurality of durations of audio content;
receive, via the second user interface, an indication of a selected duration of audio content, wherein the selected duration indicates a minimum duration of audio content and a maximum duration of audio content;
identify a group of candidate audio content shows based at least on whether category associated with each show in the group of candidate audio content shows matches the category selected via the first user interface;
select a subset of shows of the group of candidate audio content shows;
identify a group of candidate episodes associated with the subset of shows;
select a subset of episodes of the group of candidate episodes based at least on whether a duration of each episode in the subset of episodes is greater than the minimum duration and less than the maximum duration corresponding to the duration selected via the second user interface;
rank the subset of episodes; and
cause indications of the subset of episodes to be presented in a third user interface presented on the user device, wherein the indications of the subset of episodes are presented based on the ranking.

8. The system of claim 7, wherein ranking the subset of episodes comprises determining a likelihood a user of the user device will enjoy each episode in the subset of episodes, wherein the ranking is based on the likelihood.

9. The system of claim 7, wherein the group of candidate audio content shows are identified based on a popularity of each show in the group of candidate audio content shows.

10. The system of claim 7, wherein the group of candidate audio content shows are identified based on whether episodes associated with each show in the group of candidate audio content shows are likely to be relevant to a user of the user device after a predetermined duration of time has elapsed.

11. The system of claim 7, wherein the hardware processor is further configured to:
for an episode included in the group of candidate episodes, identify a portion of the episode, wherein the portion of the episode includes audio content of a particular type; and
generate a trimmed version of the episode that includes the identified portion of the episode, wherein the trimmed version of the episode is included in the subset of episodes.

12. The system of claim 7, wherein identifying the group of candidate episodes is based on an RSS feed associated with shows in the subset of shows.

13. A non-transitory computer-readable medium containing computer executable instructions that, when executed by a processor, cause the processor to perform a method for presenting audio content, the method comprising:
causing, using a hardware processor, a first user interface to be presented on a user device that indicates a plurality of categories of audio content;
receiving, via the first user interface, an indication of a selected category of the plurality of categories of audio content;
in response to receiving the indication of the selected category via the first user interface, causing a second user interface to be presented on the user device that indicates a plurality of durations of audio content;
receiving, via the second user interface, an indication of a selected duration of audio content, wherein the selected duration indicates a minimum duration of audio content and a maximum duration of audio content;
identifying a group of candidate audio content shows based at least on whether category associated with each show in the group of candidate audio content shows matches the category selected via the first user interface;
selecting a subset of shows of the group of candidate audio content shows;
identifying a group of candidate episodes associated with the subset of shows;
selecting a subset of episodes of the group of candidate episodes based at least on whether a duration of each episode in the subset of episodes is greater than the minimum duration and less than the maximum duration corresponding to the duration selected via the second user interface;
ranking the subset of episodes; and
causing indications of the subset of episodes to be presented in a third user interface presented on the user device, wherein the indications of the subset of episodes are presented based on the ranking.

14. The non-transitory computer-readable medium of claim 13, wherein ranking the subset of episodes comprises determining a likelihood a user of the user device will enjoy each episode in the subset of episodes, wherein the ranking is based on the likelihood.

15. The non-transitory computer-readable medium of claim 13, wherein the group of candidate audio content shows are identified based on a popularity of each show in the group of candidate audio content shows.

16. The non-transitory computer-readable medium of claim 13, wherein the group of candidate audio content shows are identified based on whether episodes associated with each show in the group of candidate audio content shows are likely to be relevant to a user of the user device after a predetermined duration of time has elapsed.

17. The non-transitory computer-readable medium of claim 13, wherein the method further comprises:
for an episode included in the group of candidate episodes, identifying a portion of the episode, wherein the portion of the episode includes audio content of a particular type; and
generating a trimmed version of the episode that includes the identified portion of the episode, wherein the trimmed version of the episode is included in the subset of episodes.

18. The non-transitory computer-readable medium of claim 13, wherein identifying the group of candidate episodes is based on an RSS feed associated with shows in the subset of shows.
